(19) United States
(12) Patent Application Publication
(10) Pub. No.: US 2012/0204131 A1
(43) Pub. Date: Aug. 9, 2012

(54) ENHANCED APPLICATION LAUNCHER INTERFACE FOR A COMPUTING DEVICE

(76) Inventors: Samuel HOANG, Seattle, WA (US); Donald Geoffrey Schuller, San Jose, CA (US)

(21) Appl. No.: 13/172,063

(22) Filed: Jun. 29, 2011

Related U.S. Application Data
(60) Provisional application No. 61/440,345, filed on Feb. 7, 2011.

(51) Int. Cl. G06F 3/048

(52) U.S. Cl. 715/835

(57) ABSTRACT

A system and method for providing application objects on a mobile computing device is disclosed. The method comprises automatically determining one or more categories for newly installed applications. Application meta-information about a library of installed applications, including meta-information associated with the newly installed applications, is maintained. The meta-information also includes category information. The method further comprises providing an application launch interface that presents selectable objects of individual applications that comprise the library of installed applications. Providing the application launch interface includes automatically organizing the selectable objects of individual applications by category, so that the selectable objects are displayed by category.

### RELATED APPLICATIONS

This application claims the benefit of priority under 35 U.S.C. 119(e) to Provisional Application Ser. No. 61/440,345, filed Feb. 7, 2011, titled ENHANCED APPLICATION LAUNCHER INTERFACE FOR A COMPUTING DEVICE, which is incorporated herein by reference in its entirety.

### BACKGROUND OF THE INVENTION

Mobile computing devices may provide a variety of different functionalities. A user may use a smart phone or a tablet device, for example, to download many different applications that have different functions. Some applications are used for reading news, books or magazines while some are used for streaming videos. Users may download game applications, cook book applications, crossword puzzle applications, weather applications, map applications, etc. and store all of them in their mobile computing devices.

With the number of applications that are provided on mobile computing devices increasing, an efficient way to organize the numerous applications is needed.

### BRIEF DESCRIPTION OF THE DRAWINGS

The disclosure herein is illustrated by way of example, and not by way of limitation, in the figures of the accompanying drawings and in which like reference numerals refer to similar elements, and in which:

FIG. 1 illustrates a system for providing application objects on a mobile computing device under an embodiment;

FIG. 2 illustrates a method for providing application objects on a mobile computing device, according to an embodiment;

FIG. 3 is a block diagram of a mobile computing device under an embodiment;

FIG. 4 illustrates an application launch interface that is provided on a mobile computing device under an embodiment; and

FIG. 5 illustrates an application launch interface that is provided on a mobile computing device under another embodiment.

### DETAILED DESCRIPTION

Embodiments described herein enable a user to navigate and select applications to operate on a computing device. In particular, embodiments display graphic objects of applications (“application object”), such as icons, in accordance with an organization schema that facilitates user navigation and selection of applications.

According to some embodiments, applications are categorized, and application objects are clustered by category for the user's selection. The user is able to select from categories, in order to view objects (e.g., icons) of applications that the user can select and operate. The categorical listing of application objects can be provided through a user-interface that is interactive.

In some embodiments, applications that are stored or installed in a computing device can each be represented by a selectable object or representation. An application object can include a graphic image, such as provided by an icon, which also serves as a reference to a particular application. When selected by user input, an action may be performed relating to the referenced application. The action that is performed can correspond to, for example, the application being launched. Other actions, such as changing the state of the application, may also be performed through other user input.

According to some embodiments, information associated with an application on a computing device is analyzed in order to programmatically assign the application to a particular category. In some embodiments, meta-information for application is used. Some examples include an application's name or category descriptors (e.g., game, productivity, navigation, etc.) that developers assign when uploading their application to an application store to sell. Once installed, the application name and any relevant meta-data can be used to auto-organize the installed applications.

In one or more embodiments, an application launch interface is provided on the display of the computing device to present selectable application objects for individual applications that comprise a library of installed applications on the computing device. The application launch interface can present the application objects in an organized fashion. The application objects are automatically organized using meta-information associated with individual applications of the library.

In one embodiment, the application launch interface identifies pre-determined category headings for use in organizing the library of applications. The category headings may be made selectable, and can be provided on a portion of the application launch interface to enable a user to control the presentation of the selectable application objects. The plurality of categories may include one or more of: all (e.g., all installed) applications, favorite applications, recently used applications, or recently downloaded applications. Additionally, the category designations for the plurality of applications may include a genre and subgenre.

In some embodiments, a user may also create various different selectable categories (with associated category headings) for customizing the application launch interface.

According to an embodiment, a user may interact with category headings from an application launch interface so that the application launch interface presents the application objects for individual applications that correspond to the designated category represented by the heading. The user can select from various category headings so that the selectable objects are presented by category on the application launch interface. For example, if the selectable category heading for “Recent” applications is selected, the application launch interface organizes the selectable objects so that only the applications that a user has used recently are presented. Logic may be associated with the application launch interface to determine the user's recently-used applications. Other algorithmically-driven values may be used to create other groupings of applications (e.g., the most frequently used applications, the applications that consume the most amount of user input, and/or application the user has rated highly, and so on).

Other embodiments described herein include the application launch interface presenting the selectable objects by automatically organizing them and sorting them in alphabetical order of the individual applications' names. In some embodiments, when a user selects a selectable category feature from the application launch interface so that the application launch interface presents the selectable objects of individual applications that correspond to the selected category feature, the selectable objects of individual applications can also be sorted and displayed in alphabetical order. The application launch interface can also include a plurality of graphic dividers for separating some selectable objects from each other.

In some embodiments, the display of the computing device can be a touch screen display. A user's input and/or selections can be made by a user making contact with the touch screen display. The user input can be a tap, a double tap, or other gestures (e.g., swipe or drag) on the display through use of a user-interface that interactively provides selectable application objects. The user can make contact for input by using a pointer or a finger (or multiple fingers) or other objects/body parts. In other embodiments, the application launch interface is scrollable. The user may scroll the application launch interface in one or more directions by making a swiping or dragging gesture on the touch screen display. Other embodiments include a scrolling bar that a user can hold and/or drag in the scrolling direction.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

Some embodiments described herein may be implemented using programmatic elements, often referred to as modules or components, although other names may be used. Such programmatic elements may include a program, a subroutine, a portion of a program, or a software component or a hardware component capable of performing one or more stated tasks or functions. As used herein, a module or a component can exist on a hardware component independently of other modules/components or a module/component can be a shared element or process of other modules/components, programs or machines. A module or component may reside on one machine, such as on a client or on a server, or a module/component may be distributed amongst multiple machines, such as on multiple clients or server machines. Any system described may be implemented in whole or in part on a server, or as part of a network service. Alternatively, a system such as described herein may be implemented on a local computer or terminal, in whole or in part. In either case, implementation of system provided for in this application may require use of memory, processors and network resources, including data ports, and signal lines (optical, electrical etc.), unless stated otherwise.

Some embodiments described herein may generally require the use of computers, including processing and memory resources. For example, systems described herein may be implemented on a server or network service. Such servers may connect and be used by users over networks such as the Internet, or by a combination of networks, such as cellular networks and the Internet. Alternatively, one or more embodiments described herein may be implemented locally, in whole or in part, on computing machines such as desktops, cellular phones, personal digital assistances, laptop computers, or other computing devices. Thus, memory, processing and network resources may all be used in connection with the establishment, use or performance of any embodiment described herein (including with the performance of any method or with the implementation of any system).

Furthermore, some embodiments described herein may be implemented through the use of instructions that are executable by one or more processors. These instructions may be carried on a computer-readable medium. Machines shown in figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), and magnetic memory. Computers, terminals, network enabled devices (e.g. mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

Overview

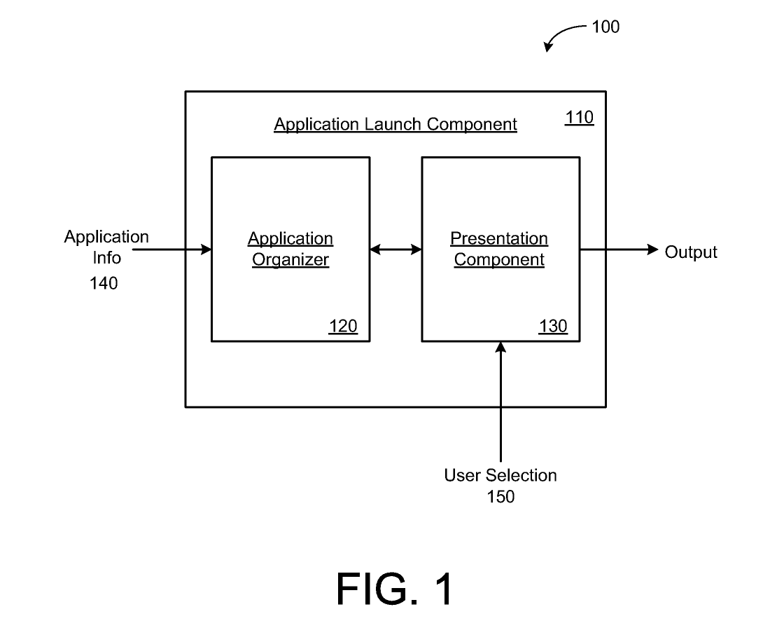

FIG. 1 illustrates a system for presenting application objects on a computing device according to an organizational schema, under an embodiment. A system such as illustrated with FIG. 1 may be implemented on, for example, a mobile computing device or small-form factor device, although embodiments may be implemented on numerous other computing form factors such as tablets, notebooks, desktops computers and the like. In an embodiment, the system 100 provides application objects on a display of the computing device by category. System 100 incorporates logic to automatically determine category assignments for individual applications that comprise the application library of the device, then organizes him interface for display in the application objects based on category assignments. The particular type of category assignments that may be used to display application objects may be specified by the user input. For example the user may select to display application objects by favorites, by subject, or in alphabetical order. In this way, the application objects are organized so that a user can easily locate the application object that he or she wants to open or launch.

As described by embodiments, a user may select category features on an application launch interface so that the application launch interface presents the selectable application objects that correspond to a selected category feature. Because a user may have numerous applications stored or installed in his or her computing device, an enhanced application launch interface enables the user to find and launch a particular application quickly and efficiently.

As examples, the computing device may correspond to any device that includes roaming wireless network and/or telephony capabilities, including cellular telephony devices and/or mobile messengers. In particular, embodiments described herein may apply to numerous kinds of mobile or small form-factor computing devices. Some types of mobile computing devices that may be configured to include embodiments described herein includes a computer telephony device, such as a cellular phone or mobile device with voice-telephony applications (sometimes called “smart phone”) or a tablet device. A computing device such as described may be small enough to fit or carry in one hand, while providing cellular telephony features in combination with other applications, such as messaging, web browsing, media playback, personal information management (e.g., such as contact records management, calendar applications, tasks lists), image or video/media capture and other functionality. Mobile computing devices in particular may have numerous types of input mechanisms and user-interface features, such as keyboards or keypads, multi-directional or navigation buttons, application or action buttons, and contact or touch-sensitive display screens. Some devices may include combinations of keyboard, button panel area, and display screen on one façade. The button panel region may occupy a band between the keypad and the display area, and include a navigation button and multiple application buttons or action buttons.

Specific types of messaging that may be performed include messaging for email applications, Short Message Service (SMS) messages, Multimedia Message Service (MMS) messages, and proprietary voice exchange applications (such as SKYPE). Still further, other types of computing devices contemplated with embodiments described herein include laptop or notebook computers, ultra-mobile computers, personal digital assistants, and other multi-functional computing devices or mobile/portable devices.

Still further, one or more embodiments may be implemented through any type of computing device such as a desktop computer that is configured to include real-time voice data exchange (e.g. through use of Internet Protocol telephony). Still further, other types of computer telephony devices exist, including standalone devices that connect directly to a telephone network (whether Internet Protocol or Public Switch Telephony System (PSTN)) and provide software interfaces and applications.

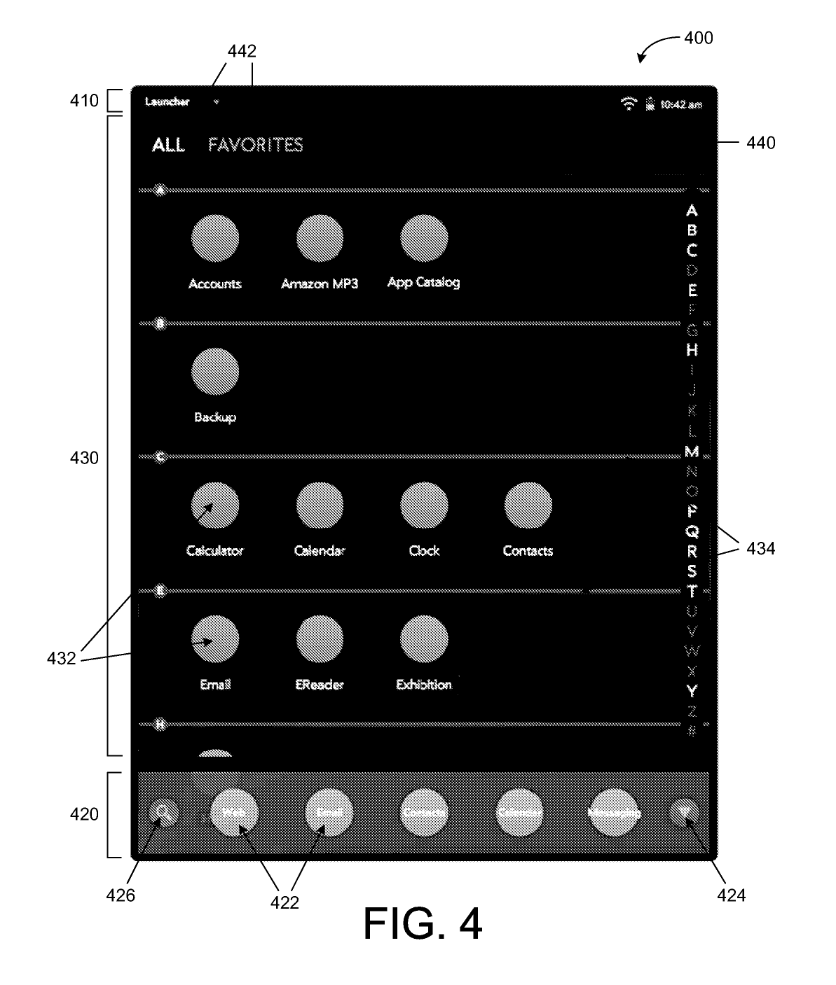

According to an embodiment, the system 100 comprises an application launch component 110. The application launch component 110 includes an application organizer 120 and a presentation component 130. Application information 140, such as meta-data, corresponding to various applications can be received by the application launch component 110 so that the application information can be maintained by the application launch component 110. The application launch component 110 is also configured to receive various user selections 150. As described, the application launch component 110 includes organization logic or programming (“application organizer 120”) and a user-interface component (“presentation component 130”). An example of the presentation component 130 is shown with FIG. 4 (“application launch interface”).

The application organizer 120 is configured to receive application information 140 from the plurality of applications. The plurality of applications can include applications such as messaging applications (e.g., SMS, MMS, instant messages, or other types), web browsing, media playback, personal information management (e.g., such as contact records management, calendar applications, tasks scheduling and lists), image or video/media capture, games, social network applications, banking and financial applications, and other applications providing various other functionalities. The application information 140 for individual applications can include meta-data that describes, for example, the type of application, content of the application, historical data (e.g., when the application was created, downloaded, last used, etc.), category information, and other types of data. Using the application information 140, the application organizer 120 can maintain the meta-data or meta-information of the installed applications.

In one or more embodiments, a user can download or install applications from an application store. Newly installed applications may include associated application information 140. Additionally, the install site may carry developer information and remarks that can also be used for purpose of application information 140. The application organizer 120 can use the meta-data of the newly installed applications to automatically determine one or more categories in which the newly installed applications correspond to. For example, if a user downloaded a YOUTUBE.COM application to view videos, the application organizer 120 may categorize the application as a video application as well as a more general, media application. The application organizer 120 can maintain the meta-information of the installed applications on a user's computing device.

Because the application organizer 120 receives information corresponding to the variety of applications, the application organizer 120 also maintains data for providing selectable application objects of individual applications. In some implementations, an application object can be a graphic image that corresponds to the individual application (e.g., a selectable icon) and/or the name or title of the application (e.g., if the applications were shown as a list, the name or title would be helpful to a user). The application objects of individual applications are presented in or as part of the application launch interface. A user selection of such application objects can correspond to, for example, a single tap, double tap, or some other action (e.g., place application object in focus, then select). Numerous embodiments contemplate a computing device that uses a touch sensitive display screen, from which user selection of application objects can include the user placing a finger or object over the region of the display where the application object is presented. For example, a selectable object of the application YOUTUBE.COM can be a graphic image of a video player, whereas a selectable object of a calculator application can be a graphic image of a small calculator. A user can select the graphic image of the YOUTUBE.COM application and the YOUTUBE.COM application will be opened or launched on the computing device.

As discussed, in some embodiments, the application organizer 120 automatically categorizes the applications using the application information 140. The application organizer 120 provides the presentation component 130 with application data. The presentation component 130 displays application objects based on a category schema in which the applications (and corresponding application objects) are organized. The organization of the applications may be based on analysis performed by the application organizer 120 on the application information 140 associated with the individual applications. The presentation component 130 displays the application objects (e.g., icons or titles) by category type on the application launch interface.

For example, a category type can be a user's recently used applications. The application organizer 120 maintains application information including meta-data that can contain historical data (e.g., when the application was created, downloaded, last used, etc.). The application organizer 120 can determine which applications have been used (e.g., launched or accessed) by the user within the past week, for example, and can categorize the applications as being recently used. Using the information from the application organizer 120, the presentation component 130 can be configured to provide the application objects depending on recent use.

In some embodiments, the application objects of the individual applications can also be sorted within the displayed application launch interface. For example, as discussed, if the category schema (which optionally can be selected by the user) that is used on the application launch interface to display the application objects is “recently used applications”, the presentation component 130 can present only those applications that fit or correspond to the recently used category. The application objects that are presented can also be sorted (e.g., in alphabetical order of the applications' names, or by time, so that the most recently used application is shown at the top). In other embodiments, the presentation component 130 includes a graphical divider to divide some of the application objects. For example, with reference to FIG. 4, the application launch interface includes dividers that sort application objects by letters. As examples, the dividers may separate by alphabetical letters, or by time. In this way, the dividers may provide a second category designation for displaying application objects in accordance with a schema.

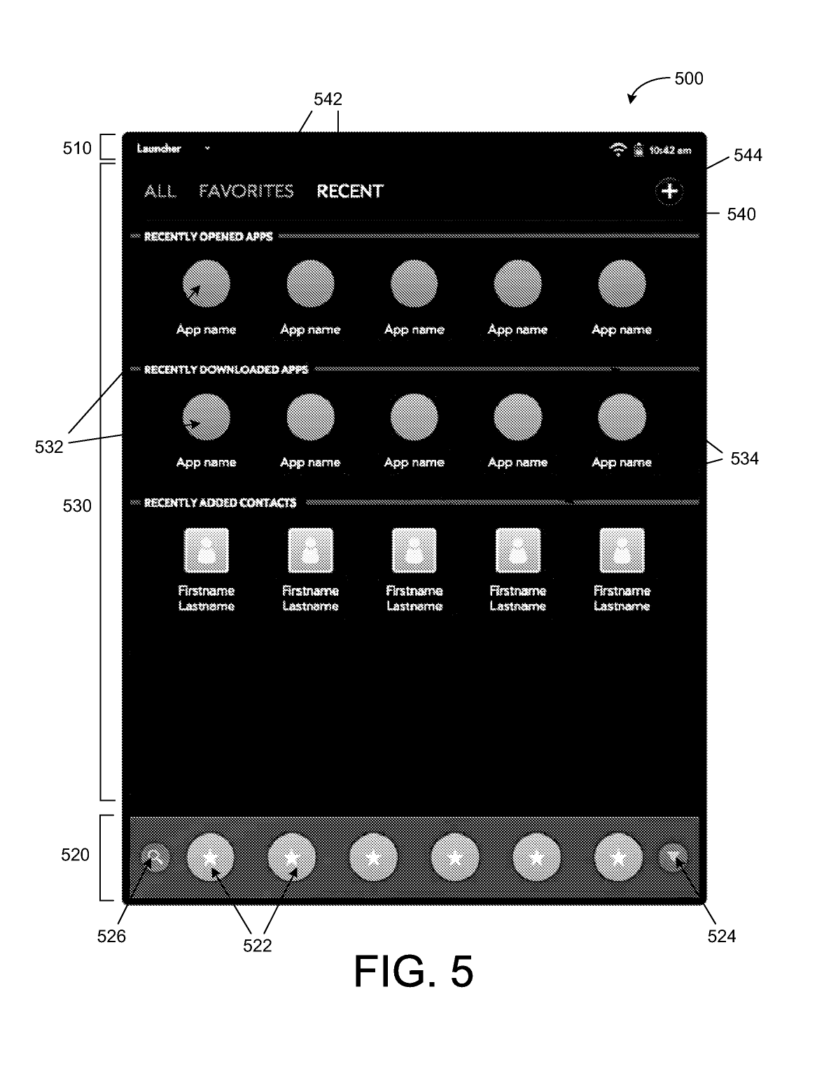

The application launch interface may also include graphic features for enabling the user to select the category schema from which application objects are organized and displayed. Such schema designation features are provided so that a user can select the category in which the applications are to be presented. In one embodiment, the category schema may be presented by text or image, and selectable with user interaction such as touch input. Examples of schema designation features are discussed with reference to FIGS. 4 and 5 below.

The presentation component 130 is configured to receive user selection input 150. User selection input 150 can include a user input or action to (i) open or launch (e.g. use or access) an application, (ii) select a selectable category feature, (iii) scroll through the application objects, (iv) manually move or reorganize the application objects that are presented, and/or (v) create a new selectable category feature.

In some embodiments, a default category is designated by a user or manufacturer so that the application objects that correspond to the default category is automatically presented when the presentation component 130 is operative. Depending on the user selection 150, such as a user input to select a category heading (e.g., the category feature for favorite applications), the presentation component 130 can automatically organize the application objects by the selected category feature and provide the application objects on the application launch interface. If the user selects a different category heading, the application objects are re-organized. Given limitations in display size, a different set of application objects may be displayed when the re-organization takes place.

As discussed, a user selection input 150, for example, can include a user input or action to create a new category heading. The application launch interface can include an icon or other graphic feature to enable a user to create a new selectable heading. In one embodiment, a user can select, hold, and drag an application object onto the graphic feature to create the new selectable category feature. Depending on the selectable object that is dragged onto the icon, the presentation component 130 can automatically create a new category heading that is based on the meta-data of the application represented by the selectable object. For example, if the user dragged a Sudoku application onto the icon for creating new selectable category features, the presentation component 130 can automatically create a “Games” category heading. In other embodiments, the user can select the icon to enable a manage or modification mode to create one or more selectable category headings.

In some embodiments, when the user creates one or more new category headings, the presentation component 130 automatically organizes the application objects of individual applications by the schema of the category headings. The presentation component 130 presents the reorganized list to the user. Meta-information may carry tags or keywords that are used by the application organizer 120 to determine categories corresponding to genre, sub-genre, and/or subject. If the user creates a new selectable category feature called “Games,” the presentation component 130 receives the user selection 150 and automatically organizes the application objects by that category using the category information. In this way, if the user selects the newly created selectable category features called “Games,” the presentation component 130 will provide the application launch interface with selectable objects of applications that correspond to gaming applications (e.g., arcade games, word games, intellectual games, etc.).

The application launch component 110 can also adjust or modify the application launch interface depending on user selections 150. In one or more embodiments, the presentation component can present application objects for individual applications in rows and/or columns.

In one or more embodiments, the presentation component 130 can adjust or modify the manner in which the application objects are displayed or presented. For example, the application objects of individual applications can be displayed iconically, or by text. In some embodiments, the user can choose the format in which the application launch interface presents the selectable objects. In other embodiments, one format (e.g., rows and/or columns of selectable objects as graphic images) can be a default format of the application launch interface. The presentation component 130 may also adjust the manner in which application objects are displayed to accommodate varying display sizes (e.g. hide some objects, present using smaller objects).

The presentation component 130 can also be configured to determine the display size of the computing device, according to an embodiment. Depending on the display size of the device (e.g., a small cell phone may have a smaller display than a larger cell phone or a tablet device), for example, the application launch interface (see FIG. 4) may be configured to be more suited for the display size of the device. For example, on a tablet device, the presentation component 130 can provides a larger region (as compared to mobile device) for displaying the application objects.

In other embodiments, the manner in which the presentation component 130 lists or displays application objects may be affected by the orientation of the computing device. Many devices can be operated in either landscape or portrait mode, depending on, for example, a manner in which a user holds the device.

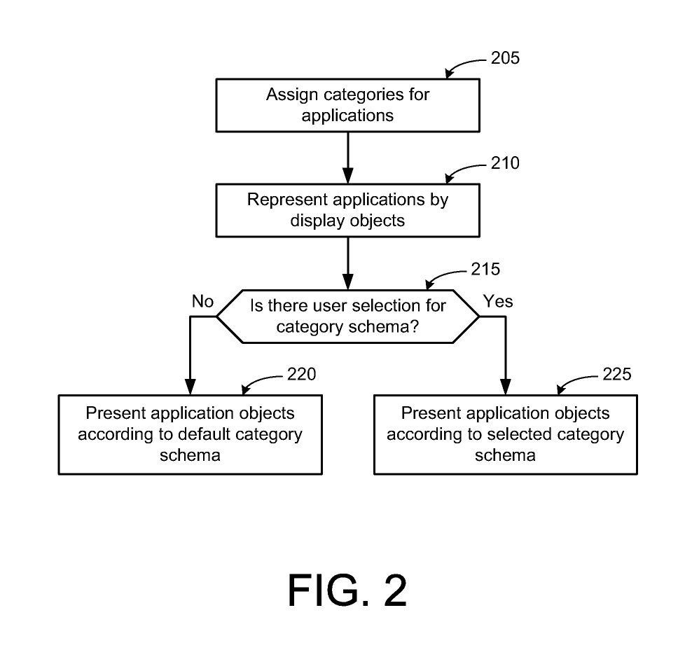

FIG. 2 illustrates a method for providing application objects on a computing device, according to an embodiment. A method such as described with FIG. 2 may be implemented using, for example, elements shown and described with FIG. 1. As such, references to elements of FIG. 1 are intended to illustrate only suitable elements for performing a step or sub-step being described.

With reference to FIG. 2, the individual applications that reside on a computing device are assigned categories in accordance with the implementation of one or more categories schemas (step 205). Individual applications may be assigned to multiple categories. More specifically, one or more category schemas may be determined, where each category schema is associated with multiple category headings. As such, the category schemas and headings may be predetermined. To assign categories to individual applications, meta-information associated with the categories is analyzed. Such information may include tagging keywords associated with an application, which can identify, for example, genres, sub genres, and subject for the individual applications. Other information that can be obtained from the meta-information include popularity of the application, the application type etc. Additionally, usage information and user preferences can also be analyzed to determine, for example, most recently used applications, most used applications, and similar information.

Under many platforms, a user is able to download an application from an application store. Such newly installed applications typically carry text description and meta-data from which application information may be identified. As with other embodiments, the application information of a newly installed application (e.g., downloaded from app store) can include one or more of the following: the type of application, content of the application, historical data (e.g., when the application was created, downloaded, last used, etc.), category information, and other types of data. Using this information, the applications (including newly installed applications) can be automatically assigned to one or more categories.

According to some embodiments, the applications may be represented by display objects (e.g., icons) (step 210). The presentation component 130 may organize the display of such application objects in accordance with a category schema. Depending on user input (step 215), the application objects are displayed according to different category schema. Absent user input or selection, a default category schema may be used to present the application objects (step 220). Else, the category schema designated by the user may be used (225). Each application may be associated with multiple categories, including categories for different category schemas. For example, one category schema may be based on popularity of use or recent use. Another category schema may be based on genre.

### Hardware Diagram

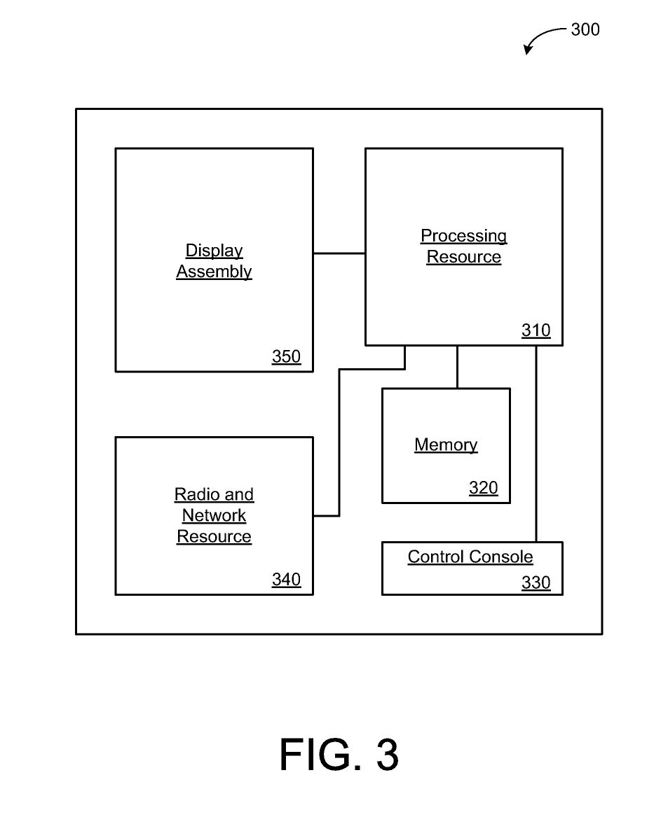

FIG. 3 is a block diagram of a computing device for implementing an architecture such as described with FIG. 1, under an embodiment. In FIG. 3, a computing device 300 includes a processing resource 310, one or more memory 320 for storing applications, display features, and data used by the applications (e.g., Flash memory, RAM, hard drive, portable storage units, etc.), a control console 330 for enabling a user to control the device 300 with user inputs, a radio and network resource 340, and a display assembly 350. In some embodiments, the control console 330 can be incorporated or be a part of the display assembly 350.

The processing resource 310 is configured to execute instructions and process data for implementing the system 100 as described with FIG. 1 so that selectable objects of individual applications can be provided on the display assembly 350 of the computing device 300. The radio and network resource 340 enables network connectivity and/or cellular telephony capabilities. The radio and network resource 340 can be configured to enable network connectivity or connectivity with other devices through use of the Wi-Fi protocol (e.g., IEEE 802.11(b) or (g) standards), Bluetooth protocol, etc.

In one or more embodiments, the display assembly 350 can include a touch screen display to enable a user to control the device 300 by making contact and movements on the touch screen display. The user selections or inputs referred to in FIGS. 1 and 2 can be performed on a touch screen display. Some user inputs can be a tap on a selectable feature on the user-interface, or other actions, such as a double tap or a gesture (e.g., a drag or swiping motion). A user can select a selectable category feature by tapping on the feature or select a selectable object of an individual application by tapping on object, such as an icon or graphic image. The user can also scroll through the application launch interface by making a swiping motion in one or more directions.

### Application Launch Interface

FIG. 4 illustrates an application launch interface that is provided on a computing device under an embodiment. The illustration described with FIG. 4 may be implemented using, for example, elements shown and described with FIGS. 1-3. As such, reference to elements of FIGS. 1-3 is intended for illustration purposes.

In one embodiment, the presentation 400 includes a status bar or notification bar 410, an application bar 420, and an application launch interface 430. The presentation 400 can be provided on a display of a computing device, such as a cell phone or a tablet device. The status bar 410 can provide a variety of different graphic items, such as a clock, a battery status icon, a network or signal strength icon, notification icons from applications, a menu bar corresponding to a current page or view that is being displayed, or other items for providing different functionalities. In some embodiments, the status bar 410 can be hidden depending on the application that is being operated or used by a user, or be automatically hidden after a duration of time.

The presentation 400 can also include an application bar 420. The application bar 420 includes a plurality of different selectable objects 422 of individual applications. Although the selectable objects 422 are illustrated as circles with words provided within them in FIG. 4, the selectable objects 422 can be different graphic images that correspond to the different applications. The objects 422 as illustrated in FIG. 4 are illustrated as circles for simplicity. For example, the “Contacts” application can have an object 422 that is a graphic image of a business card, while the “Email” application can have an object 422 that is a graphic image of an envelope. The names of the application may be included with the graphic images depending on one or more embodiments. The application bar 420 may be provided on the home screen of the computing device and may be provided when some applications are also opened or launched. In one embodiment, the application bar 420 is presented on the display of the computing device even with the application launch interface 430 being opened or launched.

In one or more embodiments, the application bar 420 also includes an application launch icon 424 (which is an application of an application object) that can be selected by a user. The application launch icon 424 can have different graphic designs depending on an embodiment. In FIG. 4, for example, the application launch icon 424 has a triangle that is pointed downward. The graphic image within the application launch icon 424 can change depending on whether the application launch interface is open or launched. If the application launch interface 430 had not been opened or launched by a user, the launch icon 424 may have a triangle (or arrow, for example) that is pointed upward. However, in FIG. 4, because the application launch interface 430 is already opened or launched, the triangle in the launch icon 424 is pointed downward. The application bar 420 can also include a selectable search icon 426, according to an embodiment. A user can select the search icon 426 to open a search page to enter input for searching an item, document, application, contact, name, phone number, or message, etc. in the computing device.

The application launch interface 430 presents selectable objects 432 of individual applications so that a user can easily find numerous applications stored or installed on the user's computing device. As discussed, the objects 432 in the application launch interface 430 can be automatically organized and then presented by category. In some embodiments, a default category can be automatically chosen or can be selected by a user so that the objects 432 that correspond to the default category is automatically provided on the application launch interface 430 when it is opened. In FIG. 4, the selected category to display the application objects 432 in the application launch interface 430 is “ALL”. “ALL” is a selectable category heading 442 that is highlighted in a different color than the other selectable category feature to show which selectable category feature is currently chosen. This category includes all of the applications that are installed or have been downloaded by the user. The category heading 442 can be provided in a portion 440 of the application launch interface 430.

As discussed, the application launch interface 430 can also include graphic dividers 434 for further organizing the selectable objects 432. In one embodiment, the objects 432 that are presented can further be sorted by alphabetical order of the applications' names. The graphic dividers 434 can correspond to the letters of the alphabet, in some embodiments. Because the objects 432 can be sorted by alphabetical order of the applications' names, the graphic dividers 434 can provide a division between letters to enable a user to quickly scroll through the application launch interface 430 to find a particular application.

The computing device, as described, can comprise a touch screen display to enable a user to input user selections and/or inputs by making contact with the touch screen display. Embodiments enable the user to select various category heading 442 for organizing and displaying application objects 432 and open/launch applications by touching or tapping on the touch screen display. For example, if the user wanted to open the Calendar application from the application launch interface 430, the user can simply tap on the selectable application object 432 corresponding to the Calendar application. In response to the selection, the Calendar application will be opened or launched on the display of the computing device. Similarly, a user can also scroll through the application launch interface 430 to view more applications that are not currently displayed on the display screen. Because of size constraints, not every object 432 of an application can be seen. For example, currently, only the applications that start with the letters “A” through “E” are fully shown. A user can scroll through the scrollable application launch interface 430 by making a swiping gesture or dragging motion on the touch screen display of the computing device in one or more directions in order to see additional objects 432 of individual applications.

FIG. 5 illustrates an application launch interface that is provided on a computing device under another embodiment. The illustration described with FIG. 5 may be implemented using, for example, elements shown and described with FIGS. 1-3. As such, reference to elements of FIGS. 1-3 is intended for illustration purposes.

Like the presentation 400 in FIG. 4, the presentation 500 includes a status bar or notification bar 510, an application bar 520, and an application launch interface 530. The presentation 500 can be provided on a display of a computing device. The status bar 510 can provide a variety of different graphic items, such as a clock, a battery status icon, a network or signal strength icon, notification icons from applications, a menu bar corresponding to a current page or view that is being displayed, or other items for providing different functionalities. In some embodiments, the status bar 510 can be hidden depending on the application that is being operated or used by a user, or be automatically hidden after a duration of time.

The presentation 500 can also include an application bar 520. The application bar 520 includes a plurality of different selectable objects 522 of individual applications. Like the presentation 400 in FIG. 4, the application bar 520 can also include an application launch icon 524 and a search icon 526.

The application launch interface 530 presents selectable objects 532 of individual applications so that a user can easily find numerous applications stored or installed on the user's computing device. As discussed, the selectable objects 532 in the application launch interface 530 can be automatically organized and then presented by category. In FIG. 4, the selected category to display the objects 532 in the application launch interface 530 is “RECENT”. “RECENT” is a selectable category heading 542 that is highlighted in a different color than the other selectable category feature to show which selectable category feature is currently chosen. This category includes recent applications that have been installed or downloaded by the user, and/or recent applications that have been accessed, and/or recent applications that have been modified, for example. The selectable category heading 542 can be provided in a portion 540 of the application launch interface 530.

The portion 540 of the application launch interface 530 can also include a modify category headings icon 544. In one embodiment, a user can select the modify category icon 544 to open or launch a manage application launch interface mode. In this mode, a user can create and/or delete category headings 542, and manually organize applications that correspond to various categories. If the user does not agree with the automatic organization of a particular application object 532, the user can access the manage application launch interface mode to modify the categories. In some embodiments, the user can create a new category heading 542 and in response to the user creation, the objects 532 can be automatically organized by that category. The newly created category heading 542 will be provided in the portion 540.

In other embodiments, a user can create a new category heading 542 by selecting an application and dragging the object 532 of that application to the modify category icon 544 (e.g., on a touch screen display, the user can tap, hold and drag the selectable object 532 to the icon 544). Depending on the type of object 532 the user drags to the icon 544, a corresponding category heading 542 can be automatically created. For example, if the user dragged a object 532 corresponding to a game application to the icon 544, a new category heading 542 called “GAMES” can be created and presented on the portion 540 of the application launch interface 530. When a user selects the “GAMES” category heading 544, a plurality of objects 532 of individual applications that correspond to the “GAMES” category will be presented on the application launch interface 530.

The application launch interface 530 can also include graphic dividers 534 for further organizing the selectable objects 532. In one embodiment, the selectable objects 532 that are presented can further be sorted by additional categories within a category. For example, the “RECENT” category includes recent applications that have been installed or downloaded by the user, and/or recent applications that have been accessed, and/or recent applications that have been modified, for example. The graphic dividers 534 can provide a division between the sub-categories that are provided on the application launch interface 530.

It is contemplated for embodiments described herein to extend to individual elements and concepts described herein, independently of other concepts, ideas or system, as well as for embodiments to include combinations of elements recited anywhere in this application. Although embodiments are described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. This, the absence of describing combinations should not preclude the inventor from claiming rights to such combinations.

What is claimed is:

1. A method for providing application objects on a mobile computing device, the method comprising:
automatically determining one or more categories for newly installed applications;
maintaining application meta-information about a library of installed applications, including meta-information associated with the newly installed applications, wherein the meta-information includes category information; and
providing an application launch interface that presents selectable objects of individual applications that comprise the library of installed applications;
wherein providing the application launch interface includes automatically organizing the selectable objects of individual applications by category, so that the selectable objects are displayed by category.

2. The method of claim 1, wherein the application launch interface includes a plurality of selectable category features that correspond to a plurality of categories.

3. The method of claim 2, wherein the plurality of categories can include at least one of: (i) all installed applications, (ii) favorite applications, (iii) recently used applications, or (iv) recently downloaded applications.

4. The method of claim 3, further comprising enabling a user to select one of the plurality of selectable category features so that the application launch interface presents the selectable objects of individual applications that correspond to the selected category feature.

5. The method of claim 1, wherein automatically organizing the selectable objects of individual applications includes sorting the selectable objects of the individual applications in alphabetical order of the individual applications' names.

6. The method of claim 5, wherein the application launch interface includes a plurality of graphic dividers for separating some of the selectable objects of individual applications from each other.

7. The method of claim 1, wherein the application launch interface is scrollable.

8. The method of claim 1, wherein the application launch interface is provided in response to a user input.

9. The method of claim 2, further comprising enabling a user to create one or more selectable category features that correspond to one or more categories.

10. The method of claim 9, further comprising enabling the user to select one of the plurality of created selectable category features so that the application launch interface presents the selectable objects of individual applications that correspond to the created selected category feature.

11. A system for providing application objects on a mobile computing device, the system comprising:
one or more processors configured to:
automatically determine one or more categories for newly installed applications;
maintain application meta-information about a library of installed applications, including meta-information associated with the newly installed applications, wherein the meta-information includes category information; and
provide an application launch interface that presents selectable objects of individual applications that comprise the library of installed applications;
wherein providing the application launch interface includes automatically organizing the selectable objects of individual applications by category, so that the selectable objects are displayed by category.

12. The system of claim 11, wherein the application launch interface includes a plurality of selectable category features that correspond to a plurality of categories.

13. The system of claim 12, wherein the plurality of categories can include at least one of: (i) all installed applications, (ii) favorite applications, (iii) recently used applications, or (iv) recently downloaded applications.

14. The system of claim 13, wherein the one or more processors are further configured to enable a user to select one of the plurality of selectable category features so that the application launch interface presents the selectable objects of individual applications that correspond to the selected category feature.

15. The system of claim 11, wherein automatically organizing the selectable objects of individual applications includes sorting the selectable objects of the individual applications in alphabetical order of the individual applications' names.

16. The system of claim 15, wherein the application launch interface includes a plurality of graphic dividers for separating some of the selectable objects of individual applications from each other.

17. The system of claim 11, wherein the application launch interface is scrollable.

18. The system of claim 11, wherein the application launch interface is presented in response to a user input.

19. The system of claim 12, wherein the one or more processors are further configured to enable a user to create one or more selectable category features that correspond to one or more categories.

20. The system of claim 19, wherein the one or more processors are further configured to enable the user to select one of the plurality of created selectable category features so that the application launch interface presents the selectable objects of individual applications that correspond to the created selected category feature.
